(19) United States
(12) Patent Application Publication
(10) Pub. No.: US 2014/0372189 A1
(43) Pub. Date: Dec. 18, 2014

(54) SYSTEM AND METHOD FOR CONSUMER-BASED STORING, RETRIEVING AND TRANSMITTING OF PROMOTIONAL CONTENT TO OTHER CONSUMERS

(71) Applicant: Konstantinos Amouris, Tinton Falls, NJ (US)

(72) Inventor: Konstantinos Amouris, Tinton Falls, NJ (US)

(21) Appl. No.: 14/341,065

(22) Filed: Jul. 25, 2014

Related U.S. Application Data
(63) Continuation of application No. PCT/US2013/023420, filed on Jan. 28, 2013.
(60) Provisional application No. 61/632,580, filed on Jan. 26, 2012.
(60) Provisional application No. 61/688,780, filed on May 21, 2012.

(51) Int. Cl. G06Q 30/02

(52) U.S. Cl. CPC G06Q 30/0267; G06Q 30/0251; G06Q 30/0214
USPC 705/14.16; 705/14.49; 705/14.64

(57) ABSTRACT

A system and method for targeted delivery of promotional messages from a sender to a receiver are disclosed. The system includes a website providing access to a plurality of promotional messages, and comprises a web-based user interface enabling the sender to create a set of promotional targeting records. A promotional targeting record comprises the sender's communication identifier, a targeted destination's communication identifier, and a selected promotional message. The created promotional targeting records are stored in a database. After a communication transmission from the sender to the receiver, system application software is used to: obtain the communication identifiers of the sender and the receiver; search the database to identify a promotional targeting record with matching sender and receiver communication identifiers; and after identifying such a promotional targeting record, retrieve from the database and deliver to the receiver the promotional message associated with the identified promotional targeting record.

### CROSS-REFERENCE TO RELATED APPLICATIONS

This application claims priority from U.S. Provisional Patent Application Ser. No. 61/632,580 filed Jan. 26, 2012 entitled “Method and System for Consumer-based Storing, Retrieving, and Transmitting of Promotional Content to Other Consumers” and U.S. Provisional Patent Application Ser. No. 61/688,780 filed May 21, 2012 entitled “Methods for Monetizing Consumer-based System of Storing, Retrieving, and Transmitting of Promotional Content to Other Consumers;” both applications are incorporated herein by reference in their entirety.

### TECHNICAL FIELD

Peer-to-Peer advertising between mobile communication devices.

### BACKGROUND

The presently disclosed system and method relate to the field of peer-to-peer advertizing that is facilitated by the heavy usage of highly sophisticated two-way communication systems, and more particularly by the continuously increasing usage of cell phones.

It is becoming increasingly evident that usage of texting has exploded over the period of the last 5-10 years, and it has become the most frequently used means of communication between cell phone users. This presents a tremendous opportunity for advertisers that can leverage both the frequency and communication mechanics of texting to deliver personalized advertisements and offers to prospective customers.

One set of the prior art (Levi et al: US 20110119131, U.S. Pat. No. 7,664,516, US 20070016921) discloses a first system and method for delivering advertisement messages selected via an intermediary website by the source of a peer-to-peer communication exchange, in conjunction with participating advertisers, to the destination of said communication exchange.

That system leverages the relationship that exists between the sender and the receiver in order to make the received advertisements more likely to be viewed since they come from a ‘trusted’ source. Consequently, this increases the likelihood of purchase of the product or service featured in the advertisement by the receiver of the advertisement.

The major limitation of that system is that it lacks a precise targeting mechanism to direct specific advertisements and promotional offers to specific destinations based on the unique knowledge that the sender has about the particular interests, needs, likes and dislikes of each particular destination that he/she communicates with. This results in inefficient distribution of advertisements and promotional offers, since while a selected advertisement/promotional offer may be a good match for destination X, it may not be a good match for destination Y.

The second limitation of that system is that it requires that both the sending and receiving devices are equipped with the operating system, memory, and processing power to run a sophisticated point-to-point application agent that is capable of downloading and transmitting advertisements to a given destination before, during, or after communication exchange. While this may hold true for smart phones or tablets, it is not true for the lower end mobile phones that are just capable of making/receiving phone calls and sending/receiving text messages. As a result, the scalability of the prior art system is inherently limited due to a significant percentage of the population still using lower end mobile phones.

Another disadvantage of that system is that it relies on downloading of advertising content to the phone from an external server accessible through the internet. As mobile phones are becoming increasingly susceptible to viruses and hacking attacks due to their continuously increasing utility to conduct financial transactions and mobile banking, frequently downloading advertising content from the internet increases the likelihood of the mobile phone doing the downloading getting infected with malicious software compromising the security of the data stored in the mobile phone.

Another set of the prior art (Fraser, Jeffrey B. et al.: US 20110275346) discloses a second system that intercepts a peer-to-peer communication and subsequently sends an advertisement or promotional message to one or both of the communicating parties based upon certain predefined conditions.

The limitation of the second system is that it lacks the element of personalization, since the communication participants do not have any input on the nature of the advertising or promotional content that is being sent and received, therefore making the delivered advertisements and promotional offers much less likely to be viewed and acted upon.

Therefore, what is needed is a sender-based peer-to-peer promotional targeting system that directly leverages the knowledge a sender has about the purchasing interests and habits of the receiver, and therefore overcomes all of the above limitations and disadvantages, significantly improving the degree of personalization and therefore the effectiveness of using peer-to-peer communications as a vehicle for delivering promotional offers.

### SUMMARY

The present disclosure provides a system for targeted delivery of promotional messages sent over a communication network from a sender associated with a source communication identifier to a receiver associated with a destination communication identifier identifying a unique communication data storage resource.

The targeting of the promotional message delivery is done by the sender through a website hosted by at least one computing device. The website provides access to a plurality of promotional messages, and comprises a web-based user interface that enables the sender to create a set of promotional targeting records, where each promotional targeting record comprises a source identifier field set equal to the source communication identifier, a destination identifier field set equal to a target destination communication identifier, and a promotional message chosen from the plurality of promotional messages.

The system further comprises a database that stores the promotional targeting records created by the sender through the website.

Furthermore, the system comprises application software for performing the following steps after initiation of a communication transmission between the sender and the receiver:

Obtaining the source communication identifier associated with the sender and the destination communication identifier associated with the receiver, and searching the database to identify at least one promotional targeting record satisfying the following logic conditions: the value of the source identifier field in the identified at least one promotional targeting record is equal to the obtained source communication identifier, and the value of the destination identifier field in the identified at least one promotional targeting record is equal to the obtained destination communication identifier;

After identifying at least one promotional targeting record that satisfies the above logic conditions, retrieving from the database and delivering to the communication data storage resource identified by the destination communication identifier the promotional message associated with the identified at least one promotional targeting record.

### BRIEF DESCRIPTION OF THE DRAWINGS

The presently disclosed system and method is described below in greater detail with reference to the accompanying drawings, in which:

FIG. 1 is a block diagram illustrating components of a promotional message targeting system in accordance with an embodiment of the disclosed system and method;

FIG. 2 is a block diagram illustrating an end-to-end promotional message targeted delivery system from a sender to a receiver in accordance with an embodiment of the disclosed system and method; and

FIG. 3 is a process flow diagram illustrating a promotional message reward delivery process in accordance with an embodiment of the disclosed system and method.

For purposes of the following discussion, letters are accompanying certain numerals in the figures in order to distinguish between different instances of the same element or component.

### DETAILED DESCRIPTION

This application claims the benefit of U.S. Provisional Patent Application Ser. No. 61/632,580 filed on Jan. 26, 2012, and U.S. Provisional Patent Application Ser. No. 61/688,780 filed on May 21, 2012 the entire disclosure of each application is hereby incorporated by reference.

The present disclosure provides for targeted delivery of promotional messages between a sender associated with a source communication identifier and a receiver associated with a destination communication identifier.

In the following discussion of the disclosed system and method, a number of acronyms and abbreviations are used, which are listed here for convenience of reference.

WUI: Web-based User Interface is a type of user interface that accepts input and provides output by generating web pages which are transmitted via the Internet and viewed by the user using a web browser program.

SMS: Short Message Service is a form of text messaging often used on mobile communication devices.

SMSC: A Short Message Service Center is a network element in mobile communication networks that processes SMS messages.

P2P: Peer-to-Peer networking is based on a distributed architecture that can distribute workload among a number of peers in the network.

SS7: Signaling System #7 is a signaling protocol for PSTN networks to implement call setup and control.

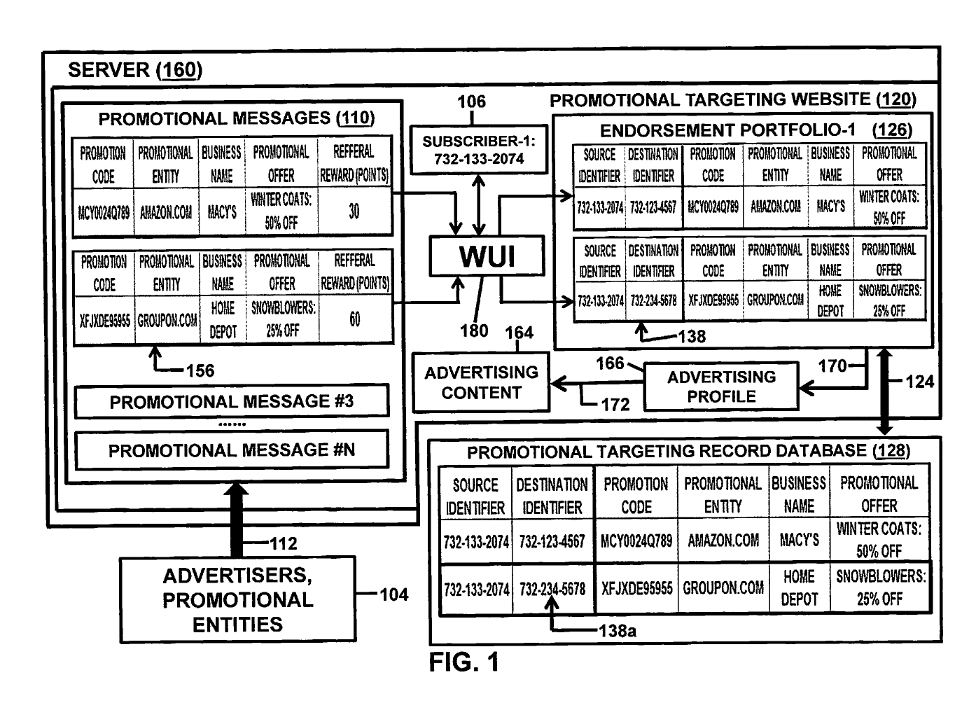

FIG. 1 is a block diagram illustrating components of a promotional message targeting system in accordance with an embodiment of the disclosed system and method. More specifically, FIG. 1 illustrates a promotional targeting website 120 maintained by at least one computing device, where the at least one computing device can be a server, a personal computer, a microprocessor, etc. In the present embodiment of the disclosed system, the at least one computing device is a computer server 160.

The promotional targeting website 120 allows a prospective subscriber 106 to create a login account and subsequently login and view a set of promotional messages 110 created and uploaded from a group of advertisers and promotional entities 104 (i.e., Amazon.com, Groupon.com), etc. The login account created by each subscriber may be uniquely associated with the subscriber's 106 mobile phone number.

The set of promotional messages 110 to be made accessible to the promotional targeting website 120 subscriber community are uploaded to the server 160 maintaining the website 120 via a web-based user interface 112 that is accessible by the community of advertisers and promotional entities 104.

With continuing reference to FIG. 1, a promotional message 156 comprises the following elements:
a) Promotion code: An alphanumeric code uniquely identifying the promotional message.
b) Promotional entity: Name of the promotional entity that is issuing the promotional message. In some cases, the entity issuing the promotional message may be different from the original business making the product or providing the service that is featured in the promotional message. This is the case with internet retailer companies such as Amazon.com (or Groupon.com) that act as intermediaries between online shoppers and businesses.
c) Business name: Name of the business making the product or providing the service featured in the promotional message.
d) Featured product or service: The featured ‘service’ may be any one of a multitude of things such as dinner at a neighborhood restaurant, tickets to a movie being promoted, membership to a neighborhood gym, oil change at a local gas station, legal advice from a local law firm, a car insurance company, a bank, an investment brokerage company, etc.
e) Promotional offer: A promotional offer related to the product or service, such as a discount that the buyer will get when he/she redeems the promotional offer by purchasing the product or service associated with the promotional message. The discount may be structured such that it contains a coupon component and a rebate component. The coupon component of the discount may be collected immediately by the buyer at the Point of Sale without any additional action required, while the rebate component of the discount will require the buyer to submit Proof of Purchase (PoP) to the promotional entity that is associated with the redeemed promotional offer.
f) Referral reward: A referral reward (i.e., offered sender reward points) to be delivered to the subscriber that did the ‘targeting’ of the redeemed promotional message to the buyer. The referral reward could also be broken into an ‘instant’ component and a ‘rebate’ component, where the instant component is immediately delivered to the sender following transmission of the promotional message to the receiver, and the rebate component is delivered contingent on the buyer providing evidence of redemption of the promotional offer (i.e., PoP).

Additionally, the promotional message may contain a web link that will direct the receiver to a web page containing additional information about the promotional offer, such as images of the product or further restrictions associated with the promotional offer.

The promotional targeting website 120 comprises a Web-based User Interface 180 (WUI) that allows each subscriber to search for promotional messages using various search criteria such as the size and structure of the referral reward, the size and structure of the promotional offer, the product or service category (i.e., movies, electronics, fragrances, etc), and the brand/business name. Furthermore, the promotional targeting website 120 comprises a WUI 180 that enables each subscriber to create promotional targeting records.

A promotional targeting record 138 is a data structure comprising the following elements:
a) A source identifier field whose value is set to the subscriber's mobile phone number,
b) A selected promotional message to be associated with the promotional targeting record, and
c) A destination identifier field whose value is set to a target destination mobile phone number to which the selected promotional message may be forwarded to when the subscriber sends an SMS message to the user associated with the destination mobile phone. This element maximizes personalization of the forwarded promotional message due to the unique knowledge the subscriber/sender has about the consumer habits of the person receiving the promotional offer, and consequently it maximizes the likelihood that a forwarded promotional offer will be redeemed.

The totality of the currently present promotional targeting records created by a subscriber 106 makes up the subscriber's endorsement portfolio 126. The promotional targeting website's WUI 180 is capable of displaying each subscriber's endorsement portfolio 126 in a tabulated format similar to the web-based user interfaces used by various investing websites to display the stock and bond portfolios of their individual investors.

In addition, the promotional targeting website's WUI 180 allows each subscriber 106 to modify his/her endorsement portfolio 126 by adding and/or deleting promotional targeting records from his/her endorsement portfolio 126 similar to the WUIs used by various investing websites that allow their investors to add and/or remove stock symbols from their stock portfolios.

The server 160 maintaining the promotional targeting website 120 is running application software that may display advertising content 164 on the promotional targeting website 120 before a particular subscriber is able to save the changes he/she has made to their endorsement portfolio 126. The advertising content 164 to be displayed may be selected based on a personalized advertizing profile 166 that is uniquely associated with the subscriber 106, where the personalized advertising profile 166 may be constructed by taking into account 170 the combined set of:
a) The promotional targeting records that the particular subscriber has created for targeted promotional message delivery to his/her friends (i.e., endorsement portfolio 126), and
b) The promotional targeting records for which the particular subscriber 106 has been designated as the ‘target’ by his/her friends who are in frequent communication with the particular subscriber.

The endorsement portfolio 126 created by each subscriber of the promotional targeting website 120 is being stored in a promotional targeting record database 128 that is communicatively coupled 124 to the server 160 maintaining the promotional targeting website 120, such that the contents of the promotional targeting record database 128 are kept concurrent with the most recent version of each subscriber's endorsement portfolio 126.

The promotional targeting records stored in the database are searchable and retrievable by a query comprising the mobile phone numbers of the source and destination involved in an SMS communication. In the event there are multiple promotional targeting records associated with the same target destination mobile phone number, the subscriber creating those records can specify rules for determining the order in which promotional targeting records should be retrieved. For example, the retrieval order could be round-robin so that each promotional targeting record is retrieved exactly once in a sequential order. Alternatively, the subscriber could assign a retrieval ‘weight’ designation to each promotional targeting record, so that a particular record is retrieved a specified percentage of the time relative to the other promotional targeting records with the same target destination identifier in his/her endorsement portfolio. Furthermore, the promotional targeting record retrieval rules could be based on other factors such as the time at which the database is being queried.

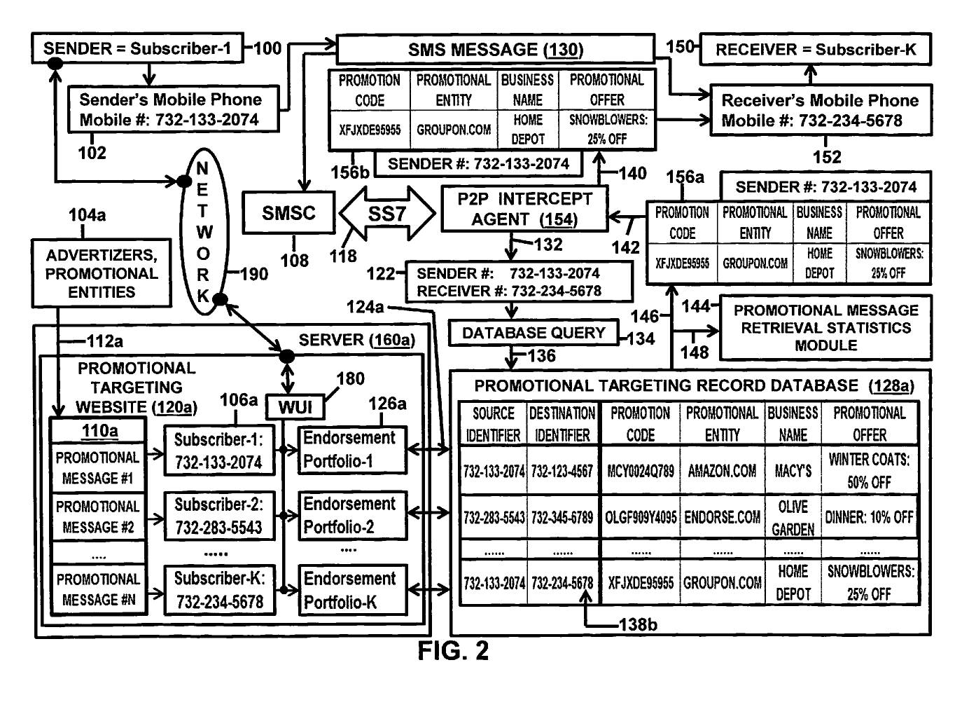

FIG. 2 is a block diagram illustrating an end-to-end promotional message targeted delivery system from a sender 100 associated with a source communication identifier 102 to a receiver 150 associated with a destination communication identifier 152 in accordance with an embodiment of the disclosed system and method.

Referring now to FIG. 2, the sender 100, who is also subscriber-1 106 of the promotional targeting website 120, creates an SMS message 130 and sends it to the intended receiver 150. Subsequently, the SMS message 130 goes through the SMSC 108 where a P2P intercept agent 154 interacting with the SMSC 108 via an SS7 signaling link 118 intercepts the SMS message 130 and obtains 132 the set of source and destination mobile phone numbers 122 involved in the intercepted SMS communication.

Subsequently, a database query 134 comprising the obtained source and destination mobile phone numbers 122 of the intercepted SMS message 130 is then constructed and used to search 136 the database 128a in order to identify a promotional targeting record satisfying the following logic conditions:
a) The value of the source identifier field in the identified promotional targeting record is equal to the obtained source mobile phone number, and
b) The value of the destination identifier field in the identified promotional targeting record is equal to the obtained destination mobile phone number.

When a promotional targeting record satisfying the above conditions 138b is identified, the promotional message 156a associated with the identified promotional targeting record 138b is retrieved 146 from the database 128a and delivered to the P2P intercept agent 154 who subsequently delivers 140 it to the destination mobile phone 152 used by the receiver 150. The P2P intercept agent 154 may be configured to package the retrieved promotional message 156b together with the SMS message 130 that triggered the promotional message retrieval and deliver both messages packaged together, or it may be configured to deliver the retrieved promotional message 156b as a separate SMS message; in the latter case (i.e., separate delivery), the P2P intercept agent 154 will insert the sender's mobile phone number to the separate SMS message carrying the delivered promotional message 156b so that the receiver 150 can later identify who the sender was.

The retrieved promotional message 156a together with the sender's mobile phone number are also being forwarded to a promotional message retrieval statistics module 144 that keeps various statistics on each promotional message retrieved from the database 128a, such as (but not limited to):

1) The total number of times it has been retrieved for transmission, for all senders,
2) The total number of different receivers it has been received by,
3) The total number of different senders that it has been forwarded by,
4) The number of times it has been retrieved for transmission, for each individual sender,
5) The number of different receivers it has been received by, for each individual sender.

Statistics (4) and (5) may then be used by the promotional entity that created each promotional message to calculate a nominal ‘transmission’ reward to be delivered to each individual sender.

The collected promotional message retrieval statistics 144 may be used by the mobile network operator whose network is being used to facilitate the communication transmission from the sender 100 to the receiver 150, for the following purposes:
a) Charging the group of advertisers and promotional entities 104 creating the promotional messages in a manner proportional to the retrieval volume 144 associated with each promotional message, similar to the ‘click-rate’ associated with advertisements and promotional offers that are posted on a web-page.
b) Informing the promotional entities 104 creating the set of promotional messages 110 about the effectiveness of their promotional campaigns.

It is understood that FIG. 2 is intended as an example, and not as an architectural limitation for different embodiments of the present disclosure. For example, the communication transmission between the sender and the receiver can be a voice call, a video-conference call, or an e-mail transmission where in the e-mail case the source and destination communication identifiers refer to e-mail addresses associated with storage memory resources residing on a remote computer e-mail server.

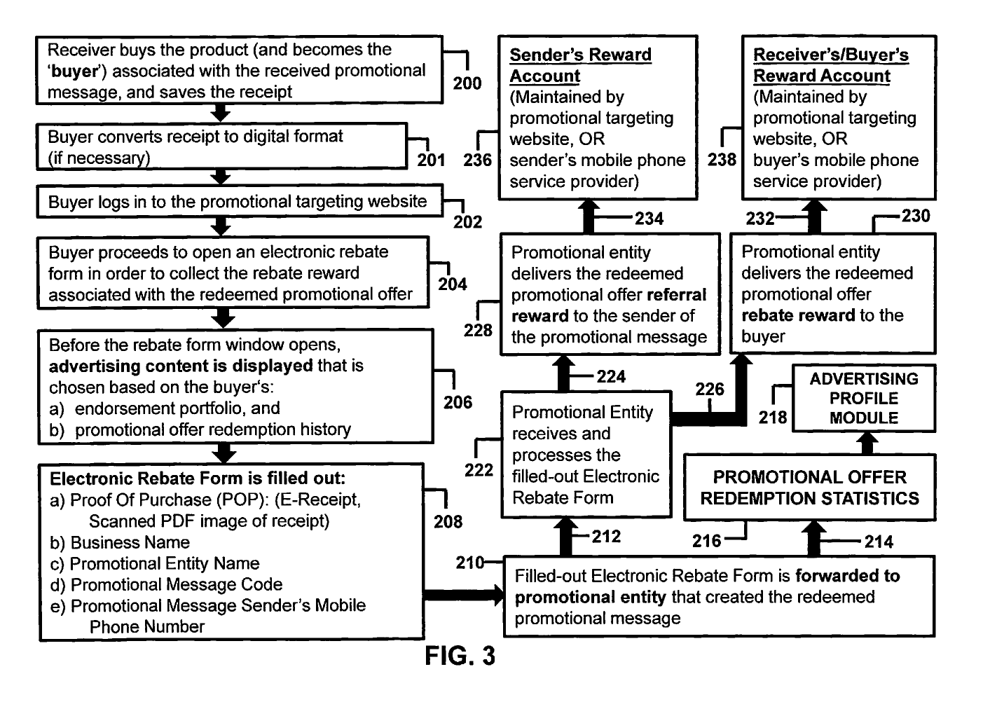

FIG. 3 is a process flow diagram illustrating the process of how the referral and rebate rewards associated with a redeemed promotional offer are delivered to the sender 100 and receiver 150 (henceforth referred to as buyer), respectively.

Referring now to FIG. 3, the reward delivery process begins with the buyer of the product or service featured in the redeemed promotional offer collecting a receipt 200 proving that the purchase actually took place (i.e., Proof of Purchase). In the present disclosure, the promotional targeting website's 120 WUI 180 enables the buyer 150 to electronically submit the PoP through the website 120. In order to use this feature, the buyer needs to first convert 201 the receipt to an acceptable digital format so that it can be uploaded to the server 160 maintaining the website 120 using the promotional targeting website's WUI 180.

Acceptable digital formats of a receipt may be one of (but not limited to) the following:
a) An E-Receipt (i.e., digital receipt) sent from the retailer to a chosen e-mail account of the buyer. Macy's is one example of a major retailer that has started to implement the E-Receipt functionality. This is the easiest way to ‘digitize’ a receipt since it's already done by the retailer and the buyer doesn't need to do anything else, other than retrieve it from his/her e-mail records.
b) A scanned PDF (Portable Document Format) image of the receipt. There are a number of receipt scanning devices in the market that can scan receipts of different sizes and formats, and allow the user to easily organize them electronically in different folders without having to worry about losing the actual paper receipt.

Once the receipt has been transformed to a digital format, the buyer 150 logs in 202 to his/her account maintained by the promotional targeting website 120, and using the website's WUI 180, proceeds to open/create 204 a new electronic (web-based) rebate form.

The website 120 may then display 206 advertising content before the buyer can fill out the electronic/web-based rebate form. The displayed advertizing content may be reflective of the buyer's prior promotional offer redemption history and/or the combined set of promotional targeting records having the buyer as their ‘target’ (i.e., records having a destination identifier field equal to the buyer's communication identifier) and the buyer's own promotional targeting records. Promotional targeting records having a particular website subscriber as their target can provide useful information about what the particular subscriber's friends may think the subscriber would be more likely to purchase.

The electronic/web-based rebate form 208 comprises the following elements:
1. Proof of Purchase (PoP) of the product or service featured in the redeemed promotional offer. The PoP comprises the digital version of the receipt. Additional elements may need to be submitted, such as a UPC bar code associated with the purchased product.
2. Name of the business making the product or providing the service in the redeemed promotional offer.
3. Name of the promotional entity that issued the promotional message.
4. The alphanumeric code identifying the promotional message, and
5. The mobile phone number of the sender whose text message triggered delivery of the redeemed promotional offer to the buyer of the product or service featured in the offer.

The application software running on the server 160 maintaining the promotional targeting website 120 then forwards 210 the completed electronic rebate form to the promotional entity (Groupon.com for this particular illustration) that created the redeemed promotional message, so that the promotional entity can deliver the promotional message rewards to the receiver/buyer 150 and sender 100 of the promotional message 156.

The reward delivery mechanism can be implemented via a rewards account (points, or dollars) that is maintained on behalf of each website subscriber by either the website administrator or the subscriber's mobile network service provider. The reward account may further be split into a dollar reward sub-account and a point reward sub-account in order to be able to receive rewards with different structures.

Once the completed electronic rebate form 208 is received and processed 222 by the appropriate promotional entity, the promotional entity (Groupon.com for this particular illustration) then does the following:
a) Delivers the rebate reward 230 (referring back to FIG. 2, this would be the “25% OFF” discount from the purchased snow blower's final sale price contained in the ‘promotional offer’ component of the delivered promotional message 156b) to the buyer's reward account 238 of the product (snow blower in this example) or service featured in the redeemed promotional offer, and
b) Delivers the referral reward 228 (referring back to FIG. 1, this would be the ‘referral reward (points)’ component of the promotional message 156, which in this example is 60 reward points) to the sender's reward account 236.

With the above embodiment in mind, it should be understood that the disclosed system can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared and otherwise manipulated.

Any of the operations described herein that form part of the disclosed system and method are useful machine operations. The disclosed system and method also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable medium, described below, can be used with computer programs written in accordance with the teachings herein, or it may be more convenient to construct a more specialized apparatus to perform the required operations.

The disclosed system and method can also be embodied as computer readable code on a computer readable medium. The computer readable medium is any data storage device that can store data, which can be thereafter be read by a computer system. Examples of the computer readable medium include hard drives, read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

Although the foregoing description has been directed to a particular embodiment of the present disclosure, it should be understood that those skilled in the art may make various changes, substitutions and alterations herein without departing from the spirit and scope of the present disclosure. For example, the communication transmission between the sender and the receiver can be a voice call, a video-conference call, or an e-mail transmission where the source and destination communication identifiers refer to e-mail addresses associated with storage memory resources allocated and residing on a remote computer server.

Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

1. (canceled)

2-24. (canceled)

25. A web-based system for enabling a plurality of consumers to create and manage a portfolio of highly-targeted endorsements for products, services, and entertainment content they would like to recommend and persistently share with their friends, the system comprising:
a database configured to support storing, retrieving, and removing of a plurality of promotional targeting records having a promotional targeting data type, the promotional targeting data type comprising an endorser identifier field, an endorsement target identifier field, and a promotional message; and
at least one computing device that is in two-way communication with said database, the at least one computing device comprising application software configured to:
maintain a website providing access to 1) a plurality of promotional messages, wherein each promotional message from said plurality of promotional messages comprises a promotional offer, and 2) a user interface capable of accepting promotional targeting record insertion, display, and removal requests from said each consumer, wherein the insertion and removal requests comprise an identifier associated with said each consumer, an identifier associated with a target consumer, and a promotional message identifier uniquely identifying one promotional message from said plurality of promotional messages accessible on the website, and wherein the display request comprises the identifier associated with said each consumer; and perform at least one of the following:
receive, via the user interface, a promotional targeting record insertion request comprising the identifier associated with said each consumer, the identifier associated with the target consumer, and the promotional message identifier uniquely identifying said one promotional message from said plurality of promotional messages accessible on the website, and cause a new promotional targeting record to be created and stored in the database, the new promotional targeting record having an endorser identifier field value set equal to the identifier associated with said each consumer, an endorsement target identifier field value set equal to the identifier associated with the target consumer, and containing said one promotional message uniquely identified by said promotional message identifier;
receive, via the user interface, a promotional targeting record display request comprising the identifier associated with said each consumer, and cause a plurality of promotional targeting records having an endorser identifier field value set equal to the identifier associated with said each consumer to be accessed from the database and get displayed on a portion of the user interface configured to display promotional targeting records; and
receive, via the user interface, a promotional targeting record removal request comprising the identifier associated with said each consumer, the identifier associated with the target consumer, and the promotional message identifier uniquely identifying said one promotional message from said plurality of promotional messages accessible on the website, and cause the promotional targeting record having an endorser identifier field value set equal to the identifier associated with said each consumer, an endorsement target identifier field value set equal to the identifier associated with the consumer, and containing said one promotional message uniquely identified by said promotional message identifier to be removed from the database.

26. The system of claim 25, wherein the identifier associated with said each consumer identifies an electronic communications account uniquely associated with said each consumer, and the identifier associated with said target consumer identifies an electronic communications account uniquely associated with said target consumer.

27. The system of claim 26, wherein the identifier associated with said each consumer identifying an electronic communications account uniquely associated with said each consumer identifies a communication device associated with said each consumer, and the identifier associated with said target consumer identifying an electronic communications account uniquely associated with said target consumer identifies a communication device associated with said target consumer.

28. The system of claim 26, further comprising at least one communication switching device that is in two-way communication with said database, wherein the at least one communication switching device comprises application software configured to:
intercept a communication transmission originated by the electronic communications account uniquely associated with said each consumer;
obtain the identifier of the electronic communications account uniquely associated with said each consumer, and the identifier of the electronic communications account uniquely associated with the destination consumer of the intercepted communication transmission;
search the database to identify at least one promotional targeting record satisfying a set of logic conditions, the set of logic conditions comprising: 1) the value of the endorser identifier field in the identified at least one promotional targeting record is equal to the obtained identifier of the electronic communications account uniquely associated with said each consumer, and 2) the value of the endorsement target identifier field in the identified at least one promotional targeting record is equal to the obtained identifier of the electronic communications account uniquely associated with the destination consumer of the intercepted communication transmission;
on identification of at least one promotional targeting record satisfying said set of logic conditions, retrieve from the database at least one promotional targeting record selectable from the promotional targeting record set consisting of the identified at least one promotional targeting record satisfying said set of logic conditions, and attach to the intercepted communication transmission the promotional message included in the retrieved at least one promotional targeting record; and
forward the intercepted communication transmission to a communication data receiving resource that is associated with the electronic communications account uniquely associated with the destination consumer of the intercepted communication transmission.

29. The system of claim 28, wherein:
the identifier of the electronic communications account uniquely associated with said each consumer identifies a communication device associated with said each consumer;
the identifier of the electronic communications account uniquely associated with the destination consumer of the intercepted communication transmission identifies a communication device associated with said destination consumer; and
the communication data receiving resource resides within the communication device associated with the destination consumer.

30. The system of claim 29, wherein the communication transmission originated by said each consumer is a text message transmission.

31. The system of claim 25, wherein the website further comprises a second user interface configured to display advertising content, and wherein the at least one computing device maintaining the website further comprises application software configured to:
obtain the identifier associated with said each consumer when said each consumer visits the website;
search the database to identify at least one promotional targeting record satisfying a set of logic conditions, the set of logic conditions comprising the following logic condition: the value of the endorsement target identifier field in the identified at least one promotional targeting record is equal to the obtained identifier associated with said each consumer; and
on identification of at least one promotional targeting record satisfying said set of logic conditions, perform the following:
retrieve from the database at least one promotional targeting record selectable from the promotional targeting record set consisting of the identified at least one promotional targeting record satisfying said set of logic conditions;
select advertising content using a data set comprising the promotional message included in the retrieved at least one promotional targeting record; and
display the selected advertising content via said second user interface configured to display advertising content.

32. The system of claim 31, wherein the selected advertising content consists of the promotional message included in the retrieved at least one promotional targeting record.

33. The system of claim 28, wherein the promotional targeting record insertion request further comprises at least one sharing preference field configured to enable said each consumer to specify and add at least one logic condition to the set of logic conditions used for searching the database.

34. The system of claim 28, wherein:
said each promotional message from said plurality of promotional messages further comprises a displayed numerical value representing the total number oftimes that all the promotional targeting records comprising said each promotional message have been retrieved from the database; and
the promotional targeting data type further comprises a database retrieval counter field configured to store a numerical value representing the total number of times that a promotional targeting record displayed on the promotional targeting record display portion of the user interface has been retrieved from the database.

35. The system of claim 25, wherein the website is further providing access to a third user interface configured to accept, from a plurality of promotional entities, promotional messages for uploading to the website and making them accessible to the plurality of consumers.

36. The system of claim 25, wherein said each promotional message from said plurality of promotional messages comprises a displayed numerical value representing the total number of promotional targeting records containing said each promotional message that have been created and inserted in the database.

37. The system of claim 25, wherein said each promotional message from said plurality of promotional messages further comprises a referral reward element.

38. The system of claim 37, wherein:
the promotional offer comprises a redemption reward element configured for delivery to the target consumer when the target consumer provides evidence of redemption of the promotional offer; and
the referral reward element is configured for delivery to said each consumer from said plurality of consumers when the target consumer provides evidence of redemption of the promotional offer.

39. The system of claim 25, wherein:
the website is further providing access to a fourth user interface configured to accept, from the target consumer, electronic evidence of redemption of the promotional offer associated with a promotional message accessed by the target consumer on the website;
said each promotional message from said plurality of promotional messages accessible on the website further comprises a displayed numerical value representing the total number of times the promotional offer associated with said each promotional message has been redeemed; and
the promotional targeting data type further comprises a redemption status field configured to store a Boolean value indicating the redemption status of the promotional offer associated with the promotional message included in a promotional targeting record displayed on the promotional targeting record display portion of the user interface.

40. A web-based method for enabling a plurality of consumers to create and manage a portfolio of highly-targeted endorsements for products, services, and entertainment content they would like to recommend and persistently share with their friends, the method comprising:
configuring a database to support storing, retrieving, and removing of a plurality of promotional targeting records having a promotional targeting data type, the promotional targeting data type comprising an endorser identifier field, an endorsement target identifier field, and a promotional message;
providing access, on a website maintained by at least one computing device, to a plurality of promotional messages, wherein each promotional message from said plurality of promotional messages comprises a promotional offer;
providing access, on said website, to a user interface capable of accepting promotional targeting record insertion, display, and removal requests from said each consumer, wherein the insertion and removal requests comprise an identifier associated with said each consumer, an identifier associated with a target consumer, and a promotional message identifier uniquely identifying one promotional message from said plurality of promotional messages accessible on the website, and wherein the display request comprises the identifier associated with said each consumer; and
performing at least one of the following steps:
receiving, at the at least one computing device, via the user interface, a promotional targeting record insertion request comprising the identifier associated with said each consumer, the identifier associated with said target consumer, and the promotional message identifier uniquely identifying said one promotional message from said plurality of promotional messages accessible on the website, and causing a new promotional targeting record to be created and stored in the database, the new promotional targeting record having an endorser identifier field value set equal to the identifier associated with said each consumer, an endorsement target identifier field value set equal to the identifier associated with said target consumer, and containing said one promotional message uniquely identified by said promotional message identifier;
receiving, at the at least one computing device, via the user interface, a promotional targeting record display request comprising the identifier associated with said each consumer, and causing a plurality of promotional targeting records having an endorser identifier field value set equal to the identifier associated with said each consumer to be accessed from the database and get displayed on a portion of the user interface configured to display promotional targeting records; and
receiving, at the at least one computing device, via the user interface, a promotional targeting record removal request comprising the identifier associated with said each consumer, the identifier associated with the target consumer, and the promotional message identifier uniquely identifying said one promotional message from said plurality of promotional messages accessible on the website, and causing the promotional targeting record having an endorser identifier field value set equal to the identifier associated with said each consumer, an endorsement target identifier field value set equal to the identifier associated with the target consumer, and containing said one promotional message uniquely identified by said promotional message identifier to be removed from the database.

41. The method of claim 40, wherein the identifier associated with said each consumer identifies an electronic communications account uniquely associated with said each consumer, and the identifier associated with said target consumer identifies an electronic communications account uniquely associated with said target consumer.

42. The method of claim 41, wherein the identifier associated with said each consumer identifying an electronic communications account uniquely associated with said each consumer identifies a communication device associated with said each consumer, and the identifier associated with said target consumer identifying an electronic communications account uniquely associated with said target consumer identifies a communication device associated with said target consumer.

43. The method of claim 41, further comprising the steps of:
intercepting a communication transmission originated by the electronic communications account uniquely associated with said each consumer;
obtaining the identifier of the electronic communications account uniquely associated with said each consumer, and the identifier of the electronic communications account uniquely associated with the destination consumer of the intercepted communication transmission;
searching the database to identify at least one promotional targeting record satisfying a set of logic conditions, the set of logic conditions comprising: 1) the value of the endorser identifier field in the identified at least one promotional targeting record is equal to the obtained identifier of the electronic communications account uniquely associated with said each consumer, and 2) the value of the endorsement target identifier field in the identified at least one promotional targeting record is equal to the obtained identifier of the electronic communications account uniquely associated with the destination consumer of the intercepted communication transmission;
on identification of at least one promotional targeting record satisfying said set of logic conditions, retrieving from the database at least one promotional targeting record selectable from the promotional targeting record set consisting of the identified at least one promotional targeting record satisfying said set of logic conditions, and attaching to the intercepted communication transmission the promotional message included in the retrieved at least one promotional targeting record; and
forwarding the intercepted communication transmission to a communication data receiving resource that is associated with the electronic communications account uniquely associated with the destination consumer of the intercepted communication transmission.

44. The method of claim 43, wherein:
the identifier of the electronic communications account uniquely associated with said each consumer identifies a communication device associated with said each consumer;
the identifier of the electronic communications account uniquely associated with the destination consumer of the intercepted communication transmission identifies a communication device associated with said destination consumer; and
the communication data receiving resource resides within the communication device associated with the destination consumer.

45. The method of claim 44, wherein the intercepted communication transmission is a text message transmission.

46. The method of claim 40, further comprising the steps of
obtaining the identifier associated with said each consumer when said each consumer visits a website selectable from a plurality of selectable websites;
searching the database to identify at least one promotional targeting record satisfying a set of logic conditions, the set of logic conditions comprising the following logic condition: the value of the endorsement target identifier field in the identified at least one promotional targeting record is equal to the identifier associated with said each consumer; and
on identification of at least one promotional targeting record satisfying said set of logic conditions, performing the following steps:
retrieving from the database at least one promotional targeting record selectable from the promotional targeting record set consisting of the identified at least one promotional targeting record satisfying said set of logic conditions;
selecting advertising content using a data set comprising the promotional message included in the retrieved at least one promotional targeting record; and
displaying the selected advertising content via an advertisement display interface on said website selectable from said plurality of selectable websites.

47. The method of claim 46, wherein the selected advertising content consists of the promotional message included in the retrieved at least one promotional targeting record.

48. The method of claim 40, further comprising the step of providing access, on said website, to a second user interface capable of accepting, from a plurality of promotional entities, promotional messages for uploading to the website and making them accessible to the plurality of consumers.

49. The method of claim 40, further comprising the steps of
associating with said each promotional message from said plurality of promotional messages accessible on the website a memory storing a counter value;
incrementing the counter value stored in said memory associated with said each promotional message upon the creation and insertion in the database of a new promotional targeting record comprising said each promotional message; and
displaying the counter value associated with said each promotional message from said plurality of promotional messages accessible on the website.

50. The method of claim 43, wherein the promotional targeting record insertion request further comprises at least one sharing preference field, and wherein the method further comprises the step of enabling said each consumer to specify and add at least one logic condition to the set of logic conditions used for searching the database.

51. The method of claim 43, wherein the promotional targeting data type further comprises a database retrieval counter field, and wherein the method further comprises the step of incrementing the value of the database retrieval counter field associated with the retrieved at least one promotional targeting record.

52. The method of claim 40, wherein each promotional message from said plurality of promotional messages further comprises a referral reward element.

53. The method of claim 52, wherein the promotional targeting data type further comprises a promotional offer redemption status field, and wherein the method further comprises providing access, on said website, to a third user interface capable of accepting, from the target consumer, electronic evidence of redemption of the promotional offer associated with a promotional message accessed by the target consumer on said website.

54. The method of claim 53, further comprising the following steps in response to the target consumer providing evidence of redemption of the promotional offer associated with a promotional message accessed by the target consumer on said website:
delivering a redemption reward element to the target consumer;
searching the database to identify at least one promotional targeting record satisfying a set of logic conditions, the set of logic conditions comprising the following logic condition: the value of the endorsement target identifier field in the identified at least one promotional targeting record is equal to the identifier associated with said target consumer; and
on identification of at least one promotional targeting record satisfying said set of logic conditions, performing the following steps:
setting the value of the promotional offer redemption status field in the identified at least one promotional targeting record satisfying said set of logic conditions to a value indicating successful redemption of the promotional offer; and
delivering the referral reward element to the consumer identified by the endorser identifier field in the identified at least one promotional targeting record satisfying said set of logic conditions.
